(19) United States
(12) Patent Application Publication
(10) Pub. No.: US 2011/0131717 A1
(43) Pub. Date: Jun. 9, 2011

(54) LAVATORY PAN

(75) Inventor: David Beale, Salisbury (GB)

(73) Assignee: WALLGATE LIMITED, Salisbury (GB)

(21) Appl. No.: 12/737,600

(22) PCT Filed: Jul. 22, 2009
(86) PCT No.: PCT/GB2009/050902

§ 371 Date: Jan. 28, 2011

(30) Foreign Application Priority Data
Jul. 31, 2008 (GB) 0814000.6

(51) Int. Cl. E03D 11/00; B28B 7/30

(52) U.S. Cl. 4/420; 264/313; 249/184

(57) ABSTRACT

Lavatory pans (2) are disclosed comprising an outlet (8) for discharging water into the pan and a passage (20) for supplying water to the outlet, the passage comprising a main portion (22) and an outlet portion (24) which is curved and has a pre-determined downward component of curvature from the main portion to the outlet. The outlet is situated below the main portion of the passage. Also disclosed are processes for producing the lavatory pans and moulding tools for use in the processes. The pans of the invention are particularly useful for secure institutions, are anti-ligature and exhibit a high flush rate.

This invention relates to lavatory pans, in particular lavatory pans for use in secure institutions. The invention also relates to processes for producing such lavatory pans and moulds for use in such processes.

Lavatory pans, as described, for example, in GB 2404927 are known.

Sanitary ware in public, and especially in secure, institutions can be subject to vandalism.

GB-A-2,353,967 discusses a moulding tool for use in producing a vandal resistant WC-pan.

Inmates in secure institutions occasionally use sanitary ware to self-harm, including by using the sanitary ware as purchase points including for ligatures.

It is important, therefore, that sanitary ware is anti-ligature, i.e. that it is designed and constructed to reduce or eliminate the potential for use as a point of purchase for ligatures taking into account the items generally available to inmates in secure institutions. Sanitary ware for secure institutions should, in any event, be designed and constructed to reduce any potential for its misuse to harm persons in the institution.

Sanitary ware should also be durable and resistant to vandalism including being fire-resistant.

It is also important that, in the case of lavatories for secure institutions, the flushing rate (i.e. volume of flushing water per unit time) is relatively high to ensure that standards of hygiene are maintained.

It is, however, difficult to ensure that both the anti-ligature problem is addressed and high flushing rate is provided.

Although vandal resistant lavatory pans have been manufactured, improvements are nonetheless required.

It is an aim of the present invention to address these problems.

The present invention accordingly provides a lavatory pan comprising at least one outlet for discharging water into the pan, and a passage for supplying water to the outlet, the passage comprising a main portion and an outlet portion connecting the main portion to the outlet, wherein the outlet is situated below the main portion of the passage and wherein the outlet portion is curved and has a predetermined downward component of its curvature down from the main portion to the outlet.

The predetermined downward component of curvature is preferably such as to reduce the possibility of purchase points being found in the lavatory pan.

Thus, the advantage of the outlet portion being curved and having a significant component of its curvature in a downward direction is that it reduces the chance that a purchase point can be found in the outlet and/or the outlet portion. This reduces the chance of a ligature being fixed to the outlet and thereby reduces the dangers of self-harm. Generally, the angle of curvature will be 10° to 90°, preferably 20 to 60°, more preferably 30 to 50°.

Preferably, the outlet is a front outlet, situated generally in the front portion of the pan.

Preferably, there are two or more outlets, water being supplied to each outlet by a passage as discussed above. Two outlets generally have the advantage of increasing the flush water flow rate into a lavatory pan which is a great benefit for hygiene, especially in public institutions.

Preferably, the, or each, outlet portion has a narrow section and the outlet portion tapers in from the outlet to the narrow section (i.e. relatively wide at the outlet, narrowing to the narrow section). This is greatly advantageous because it reduces the chance of a purchase point being found in the outlet or outlet portion.

Preferably, the outlet portion also tapers out from the narrow section to the main portion of the passage (i.e. widens from the narrow section to the main portion). This reduces the adverse effect of the narrowing of the outlet section on flow rate. If the outlet portion tapers from the narrow section both towards the outlet portion and towards the main portion of the passage then the narrow section forms a neck in the outlet portion.

In order to increase the flush flow rate as much as possible, preferably the lavatory pan further comprises additional outlets. These outlets may be towards the front portion of the lavatory pan but at least one is preferably a rear outlet situated in the rear portion of the lavatory pan. Generally, at least one of the additional outlets is a top outlet so arranged that it directs water around the top portion of the pan.

If there are two (or more) additional outlets, especially if the outlets are relatively close together, it is preferable if there is a barrier between them (so that there is no continuity) thus reducing or avoiding the possibility of a ligature or other object being threaded between them. Thus, if there are two or more additional outlets, preferably a barrier plate is situated, preferably cast, into the pan between the additional outlets.

Preferably, in order to avoid dangers of damage to the lavatory pan and for safety reasons, the or each passage is entirely or partially enclosed within the pan wall.

Preferably, the main portion of the passage comprises a separate pipe or tube incorporated in the pan, preferably during manufacture. The separate pipe or tube will usually be a plastics pipe or tube and this has the additional benefit of, if the lavatory pan is produced by a moulding process, acting as a former for the passage which may remain in situ after disassembly of the mould.

Preferably, the or each passage is situated in the top portion of the pan close to the top edge of the pan but inside the body of the pan. The main portion of the passage will be generally horizontal, substantially following the top edge of the pan.

Preferably, the or each outlet is elongate, optionally with the long axis of the outlet angled with respect to the top edge of the pan. The angle is preferably substantially a right angle so that the long axis of the outlet would be substantially perpendicular to the top edge of the pan. However, in other embodiments, the long axis of the outlet may be at a shallower angle to the top edge, forming a sloping outlet.

Preferably, the lavatory pan will be substantially rimless to avoid the possibility of a rim being used as a purchase point. The top edge of the pan will usually be formed so as to function as a seat. Generally, a separate seat would not be attached to the pan. This reduces potential for vandalism and also reduces the creation of possible purchase points.

The lavatory pan will generally comprise a (plastics) resin, preferably incorporating a fire-retardant material. Suitable fire-retardant materials are aluminium compounds, in particular aluminium oxide trihydrate. Boron compounds may also be useful. Suitable resins include polyester resins, preferably isophthalic polyester resins.

The outlet portion of the passage will preferably, in addition to the downward component of curvature, have a significant sideways component of curvature around the main portion to the outlet (i.e. horizontal component to the curvature). The angle of curvature will generally be 45° to 120°, preferably 60° to 110°, more preferably 80° to 90°. This also contributes to solution of the anti-ligature problem.

The invention provides, in a second aspect, a process for producing a lavatory pan, the process comprising,

a) providing and/or assembling a mould, the mould comprising
i) an outlet former for forming an outlet for discharging water into the pan,
ii) at least one set of passage formers, each set comprising a main portion former for forming the main portion of the passage and an outlet portion former for forming the outlet portion of the passage connecting the main portion of the passage to the outlet,
   wherein the outlet former, main portion former and outlet portion former are situated so that they form a pan having the outlet below the main portion, and a curved outlet portion having a downward component of curvature down from the main portion to the outlet,
b) filling the mould with a moulding composition,
c) curing the moulding composition and, optionally,
d) disassembling the mould.

Preferably, the outlet portion former comprises an elastomeric polymer. Generally, the outlet portion former further comprises a separate core adapted to be withdrawn, after curing and during disassembly of the mould, through the outlet of the pan.

The outlet portion former and main portion former are adapted so that the outlet portion former can be withdrawn through the main portion during disassembly of the mould. A great benefit of a separate core, and alternatively or, in addition, the outlet portion former being withdrawn through the main portion during disassembly of the mould, is that the outlet may be made smaller than would otherwise be possible if the outlet portion former were to be withdrawn through the outlet itself. This also provides the great benefit of reducing the ligature problem. Typically, a tether is fixed to the outlet portion former which runs through the main portion former for use in withdrawing the outlet portion former.

The present invention provides, in a third aspect, a mould for use in a process for producing a lavatory pan, the mould comprising a) an outlet former for forming an outlet for discharging water into the pan, b) at least one set of passage formers, each set comprising a main portion former for forming the main portion of the passage and an outlet portion former for forming the outlet portion of the passage connecting the main portion of the passage to the outlet, wherein the outlet former, main portion former and outlet portion former are situated so that they form a pan having the outlet below the main portion and a curved outlet portion having a downward component of curvature down from the main portion to the outlet.

Lavatory pans according to the invention may be installed, together with cisterns and water supply pipes in buildings, especially in institutions.

By way of example, embodiments of the present invention will now be described with reference to the accompanying drawings in which

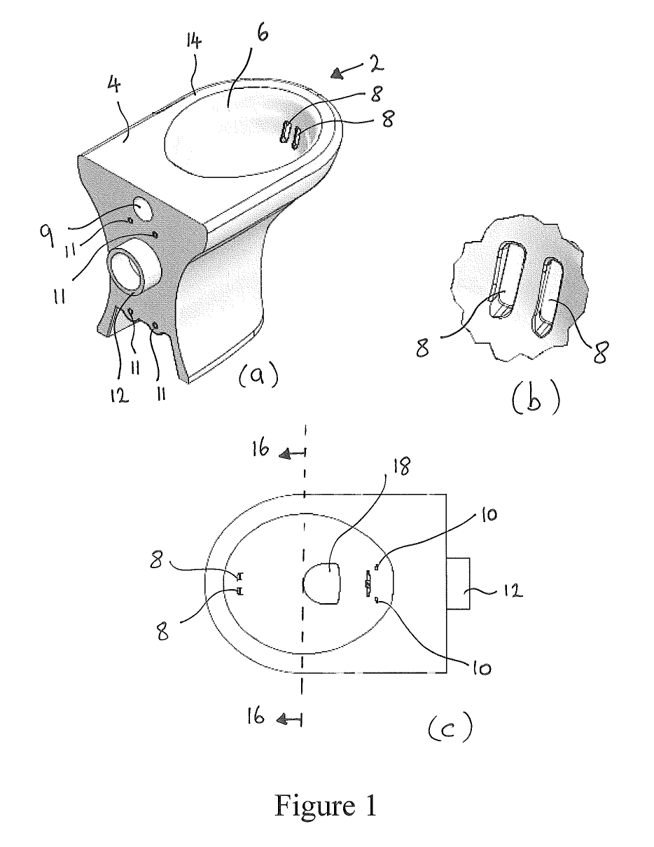

FIG. 1a illustrates a lavatory pan according to the present invention,

FIG. 1b illustrates in detail twin outlets illustrated in FIG. 1a,

FIG. 1c illustrates, in plan view, the lavatory pan according to the present invention,

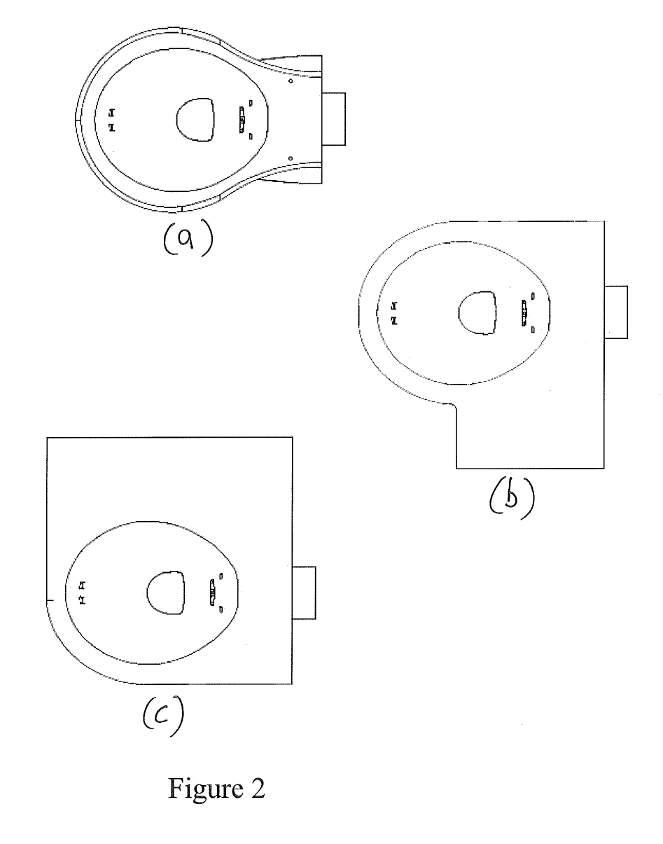

FIGS. 2a, b and c illustrate, in plan view, other lavatory pans according to the present invention intended to be installed for different locations,

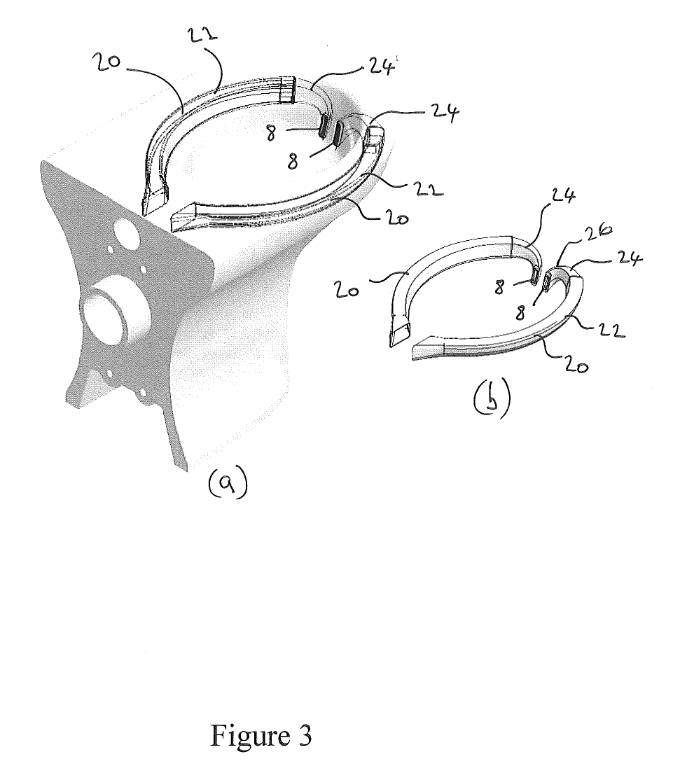

FIGS. 3a and b illustrate, in perspective view and showing internal structure of the passages, the outlet portion of the passages and outlets according to the present invention, and

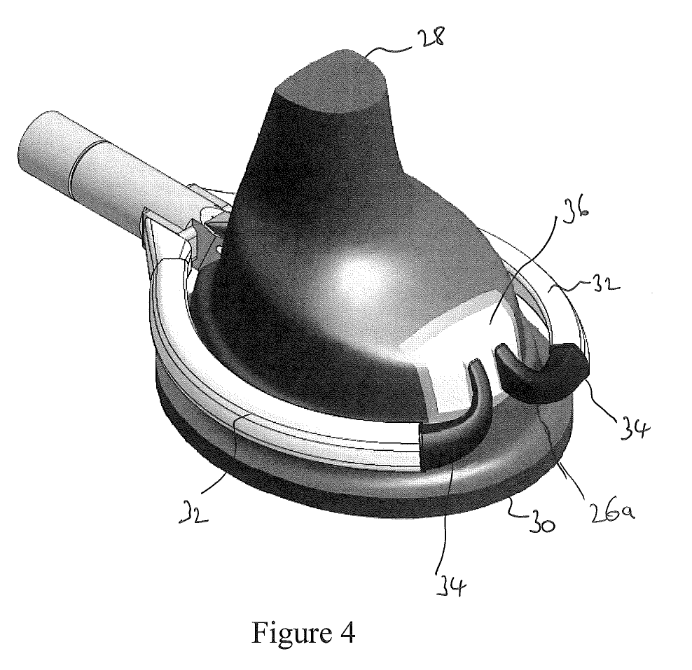

FIG. 4 illustrates part of a mould used to produce lavatory pans according to the present invention.

FIG. 1 illustrates a lavatory pan 2 according to the present invention. The pan 2 comprises a body 4 of polymer resin with a bowl portion 6 and twin outlets 8 whereby flushing water may be discharged into the bowl portion 6 of the lavatory pan 2. There are additional outlets 9 and 10 also for flushing water to the bowl portion 6 of the lavatory pan 2. The outlets 8 are at the front portion 16 of the lavatory pan 2, whereas the additional outlets 9 and 10 are at the rear portion of the pan. There is a waste pipe 12 through which waste is removed from the pan 2 after flushing. Four wall fixings 11 consist of threaded inserts cast into the pan 2.

FIG. 1b is a detail of the outlets 8. The outlets 8 are elongate with the long axis being substantially perpendicular to the top edge 14 of the lavatory pan 2. Each outlet 8 is of a small enough size to minimise the possibility of objects, or fingers, being placed into the outlets and gaining purchase. Typical dimensions of the elongate outlets 8 are 10-20 mm wide (on the short axis) and 30-50 mm long. Generally, the elongate outlets 8 will be approximately 15 mm wide and 40 mm long.

FIG. 1c illustrates, in plan view, the lavatory pan 2, the outlets 8 being in the front portion 16 of the pan. The inlet 18 to the waste pipe 12 is also shown, together with the additional outlets 9 and 10. The additional outlets 10 may be arranged so that flushing water is directed from the additional outlets 10, generally around the top portion of the lavatory pan 2.

The pan 2 is so designed that there is no continuity between the additional outlets 9 and 10 to prevent a ligature being threaded through and between the additional outlets 9 and 10. To avoid this, a barrier plate (of stainless steel, not shown) is cast into the pan 2 located centrally between the additional outlets 9 and 10.

FIG. 2 illustrates plan views of various lavatory pans intended for different locations in a sanitary facility. FIG. 2a illustrates a plan view of a lavatory pan especially for use in public facilities where the anti-ligature problem is less important. FIGS. 2b and 2c illustrate plans for lavatory pans intended to be placed in a corner, especially of a secure unit. The features illustrated in FIG. 2a, b and c are generally as discussed above and illustrated in FIG. 1c.

FIG. 3 illustrates, in perspective, a lavatory pan according to the present invention with the passages 20 for flushing water to the outlets 8 shown. Each passage 20 (clearly in some embodiments of the present invention, there may be only one passage 20 rather than twin passages 20 illustrated in FIG. 3) comprises a main portion 22 of plastics pipe or tube (of generally rectangular cross section) and an outlet portion 24 which, in the lavatory pan 2 once it has been disassembled from the mould, would be defined by the shape of the polymer resin. The outlet portions 24 discharge through the outlets 8. As is shown in FIG. 3, each outlet portion is significantly curved with components of curvature both generally in the horizontal plane (i.e. roughly parallel with the top edge 14) and also from the main portion 22 of the passage 20 downward to the outlet. The downward component of curvature is of great benefit in reducing the creation of purchase points for ligatures. Similarly, the horizontal component of curvature contributes to solving the anti-ligature problem. Each outlet portion has a neck 26 where the outlet portion 24 narrows. The outlet portion 24 tapers out both in the direction of the main portion 22 and also the outlet 8 from the neck 26 section. The neck 26 helps with solving the anti-ligature problem and because of tapering out to the main portion 22 ensures that flush performance is as good as possible.

FIG. 4 illustrates part of a mould used to form the lavatory pan according to the present invention. The mould comprises a mould plug 28 for forming the bowl portion 6 of the lavatory pan and a base portion 30. Water pipes 32 are plastics pipes which, in the finished lavatory pan 2, will form the main portions 22 of the passages 20. Fitted into the outlet end of the water pipes 32 are outlet portion formers 34 composed of an elastomeric material, typically silicone or other rubber. The outlet portion formers 34 fit tightly into the water pipes 32 to prevent ingress of uncured resin during the moulding process. The outlet portion formers 34 connect to the outlet former tooling 36. Each outlet portion former 34 has a central core (not shown) of a more rigid material than the silicone rubber typically used to form the outlet portion former 34. This core may be removed (e.g. through the outlets 8) during disassembly of the mould after curing and then the outlet portion formers 34 may be withdrawn through the water pipes 32 using a tether (not shown) connected to the outlet portion former 34. The great benefit of withdrawing the outlet portion former 34 through the water pipe 32 is that it enables design freedom and, in particular, enables a neck portion 26a of the outlet portion former 34 to form the neck 26 of the outlet portion in the finished lavatory pan 2. It also enables a smaller outlet 8 to be produced because there is no necessity for withdrawing the outlet portion formers 34 through the outlet during disassembly of the mould.

The production of a lavatory pan according to the present invention starts with assembly of the mould, generally illustrated in FIG. 4, and covering tooling (not shown) to form the outer shape of the lavatory pan. Resin composition is poured or injected into the mould, once assembled, and the resin cured by action of a catalyst. After cooling, the mould may be disassembled, including by withdrawal of the outlet portion formers 34 through the water pipes 32 after the cores (not shown) have been withdrawn through the outlets 8. In the finished lavatory pan 2, the water pipes 32 form the main portion 22 of the passages 20. The water pipes consequently are not removed during disassembly of the mould.

The resin composition may be any suitable resin which provides durability and fire-retardancy, as well as other anti-vandal properties. Typically, the composition will comprise a polyester resin, in particular an isophthalic polyester resin compatible with fire-retardant and other additives.

Curing of such a composition may be catalysed by e.g. methyl ethyl ketone peroxide.

Preferably, fire-retardant materials, for example aluminium oxide trihydrate, are incorporated in the resin composition to provide fire-retardancy. Colourants, and other additives, whether strengthening or otherwise, may also be added to the resin composition to provide other properties in the finished lavatory pan.

Lavatory pans according to the invention and as illustrated in the Figures and described above have been tested and deemed acceptable for anti-ligature properties in accordance with UK Government procedures and standards, especially for secure institutions such as prisons.

Lavatory pans according to the invention connected to standard cisterns and using standard valves have also passed the WRAS flush performance standards (1.85 litres per second in 2.7 seconds). Thus, lavatory pans according to the present invention provide solutions both to the anti-ligature problem and the flushing problem.

1-25. (canceled)

26. A lavatory pan comprising,
at least one outlet for discharging water into the pan, and
a passage for supplying water to the outlet, the passage comprising a main portion and an outlet portion connecting the main portion to the outlet,
wherein the outlet is situated below the main portion and wherein the outlet portion is curved and has a predetermined downward component of curvature from the main portion to the outlet.

27. The lavatory pan as claimed in claim 26, wherein the outlet is a front outlet, situated in the front portion of the pan.

28. The lavatory pan as claimed in claim 26, wherein there are two or more outlets, water being supplied to each outlet by a passage.

29. The lavatory pan as claimed in claim 26, wherein the or each outlet portion has a narrow section and the outlet portion tapers in from the outlet to the narrow section.

30. The lavatory pan as claimed in claim 29, wherein the or each outlet portion tapers out from the narrow section to the main portion of the passage.

31. The lavatory pan as claimed in claim 26, further comprising additional outlets.

32. The lavatory pan as claimed in claim 31, wherein at least one of the additional outlets is a rear outlet, situated in the rear portion of the pan.

33. The lavatory pan as claimed in claim 31, wherein at least one of the additional outlets is a top outlet so arranged that it directs water around the top portion of the pan.

34. The lavatory pan as claimed in claim 31, further comprising a barrier plate situated in the pan between two or more additional outlets.

35. The lavatory pan as claimed in claim 26, wherein the or each passage is entirely or partially enclosed within the pan wall.

36. The lavatory pan as claimed in claim 35, wherein the main portion comprises a separate pipe incorporated in the pan during manufacture.

37. The lavatory pan as claimed in claim 35, wherein the or each passage is situated in the top portion of the pan.

38. The lavatory pan as claimed in claim 26, wherein the or each outlet is elongate optionally with the long axis of the outlet angled with respect to the top edge of the pan.

39. The lavatory pan as claimed in claim 26, wherein the pan is substantially rimless.

40. The lavatory pan as claimed in claim 26, wherein the pan is adapted for use without a separate seat.

41. The lavatory pan as claimed in claim 26, wherein the pan comprises resin, preferably plastics resin.

42. The lavatory pan as claimed in claim 41, wherein the resin includes a fire retardant material.

43. The lavatory pan as claimed in claim 37, wherein the main portion substantially follows the top edge of the pan.

44. The lavatory pan as claimed in claim 43, wherein the outlet portion also has a significant sideways component of curvature around from the main portion to the outlet.

45. A process for producing a lavatory pan, the process comprising,
a) providing a mould, the components of the mould comprising
i) an outlet former for forming an outlet for discharging water into the pan,
ii) at least one set of passage formers, each set comprising a main portion former for forming the main portion of the passage and an outlet portion former for forming the outlet portion of the passage connecting the main portion of the passage to the outlet,
wherein the outlet former main portion former and outlet portion former are situated so that they form a pan having the outlet below the main portion, and a curved outlet portion having a downward component of curvature down from the main portion to the outlet,
b) filling the mould with a moulding composition,
c) curing the moulding composition, and optionally
d) disassembling the mould.

46. The process as claimed in claim 45, wherein the outlet portion former comprises an elastomeric polymer.

47. The process as claimed in claim 45, wherein the outlet portion former further comprises a separate core adapted to be withdrawn, after curing and during disassembly of the mould, through the outlet of the pan.

48. The process as claimed in claim 47, wherein the outlet portion former and main portion former are adapted so the outlet portion former can be withdrawn through the main portion during disassembly of the mould.

49. A mould for use in a process for producing a lavatory pan, the mould comprising
a) an outlet former for forming an outlet for discharging water into the pan,
b) at least one set of passage formers, each set comprising a main portion former for forming the main portion of the passage and an outlet portion former for forming the outlet portion of the passage connecting the main portion of the passage to the outlet,
wherein the outlet former main portion former and outlet portion former are situated so that they form a pan having the outlet below the main portion, and a curved outlet portion having a downward component of curvature down from the main portion to the outlet.
